(19) United States
(12) Patent Application Publication
(10) Pub. No.: US 2022/0387836 A1
(43) Pub. Date: Dec. 8, 2022

(54) FIRE EXTINGUISHING LIQUID

(71) Applicant: Lifesafe Technologies Limited, Essex (GB)

(72) Inventors: Gavin CORNELIUS, London (GB); Tony CRAWLEY, Essex (GB)

(21) Appl. No.: 17/771,065

(22) PCT Filed: Oct. 23, 2019
(86) PCT No.: PCT/EP2019/078933

§ 371 Date: Apr. 22, 2022

(51) Int. Cl. A62D 1/00; A62D 1/02

(52) U.S. Cl. CPC A62D 1/0035; A62D 1/0071

(57) ABSTRACT

A fire extinguishing liquid comprising: one or more of a phosphate, hydrogen phosphate or dihydrogen phosphate salt; a hydrogen carbonate salt; and a sulphate salt.

### TECHNICAL FIELD OF THE INVENTION

The present invention relates to fire extinguishing liquids, methods of manufacturing fire extinguishing liquids, and fire extinguishers containing those liquids.

### BACKGROUND TO THE INVENTION

Some fire extinguishers are filled with liquid, herein referred to as ‘fire extinguishing liquid’. There are a number of properties which are desirable for the fire extinguishing liquid. Firstly, it must be effective at suppressing and extinguishing fires. This can be achieved in a number of ways, which are discussed in detail in the “Summary of the Invention” section below. The components contained in the fire extinguishing liquid are selected to maximize its effectiveness.

It is desirable for fire extinguishing liquids to be effective over a wide range of temperatures. However, particularly in cold climates, the types of fire extinguisher which can be used are restricted. This is because the fire extinguishing liquid is often stored in pressurized containers, and there are safety risks associated with the liquid freezing. In addition to the safety risks, the low temperature can cause (a) freezing of the fire extinguishing liquid and (b) dissolved components in the liquid to come out of solution. Solid particulate matter inside the fire extinguisher can lead to undesirable consequences such as clogging of the nozzle.

Furthermore, there is a need for further fire extinguishing liquids which are effective against a range of different types of fire. Different types of fire according to the European standard EN3 include Class A (fires involving organic solids, e.g. wood, paper), Class B (fires involving flammable liquids), Class C (fires involving flammable gases) and Class F (fires involving cooking oil and fat). It is rare for a given fire extinguishing liquid to be effective against multiple fire types.

### SUMMARY OF THE INVENTION

Broadly speaking, the present invention provides a fire extinguishing liquid which demonstrates an improved ability to extinguish fires quickly and safely relative to known compositions and is effective against a range of fire types. In order to achieve this, a first aspect of the present invention provides a fire extinguishing liquid comprising:
(a) one or more of a phosphate, hydrogen phosphate or dihydrogen phosphate salt;
(b) a hydrogen carbonate salt; and
(c) a sulphate salt.

The inventors have found that such a fire extinguishing liquid meets European standards for extinguishing at least fire types A and F. The liquid is therefore more versatile than many existing fire extinguishing liquids.

Herein, phosphate, hydrogen phosphate and dihydrogen phosphate salts are salts including the anions PO₄³⁻, HPO₄²⁻ and H₂PO₄⁻ respectively.

A hydrogen carbonate salt is a salt including the anion HCO₃⁻.

A sulphate salt is a salt including the anion SO₄²⁻.

Preferably, the salts are each water-soluble. In some embodiments, each of the salts has a solubility in distilled water at 20° C. of at least 5 g/100 mL, for example at least 6 g/100 mL, for example at least 10 g/100 mL, for example at least 15 g/100 mL, for example at least 20 g/100 mL.

The counter-ion to the above-mentioned anions may be selected from any suitable cation which combines with the anion to form a salt having the above solubility. Non-limiting examples of cations are alkali metal ions, alkaline earth metal ions, transition metal ions and organic cations such as ammonium ion (NH₄⁺) or primary, secondary, tertiary or quaternary ammonium cations (NH₃R^{+; NH}₂R₂⁺; NHR₃⁺ or NR₄⁺ respectively, wherein each R is independently selected from C₁₋₄ saturated alkyl groups). Preferably, the counter cation is selected from alkali metal ions, alkaline earth metal ions and ammonium ion (NH₄⁺).

In some embodiments, the phosphate salt is selected from trisodium phosphate (Na₃PO₄) and tripotassium phosphate (K₃PO₄).

In some embodiments, the hydrogen phosphate salt is selected from disodium phosphate (Na₂HPO₄), dipotassium phosphate (K₂HPO₄) and diammonium hydrogen phosphate ((NH₄)₂HPO₄). In some embodiments, the hydrogen phosphate salt is diammonium hydrogen phosphate ((NH₄)₂HPO₄).

In some embodiments, the dihydrogen phosphate salt is selected from monosodium phosphate (NaH₂PO₄), monopotassium phosphate (KH₂PO₄) and monoammonium phosphate ((NH₄)H₂PO₄).

In some embodiments, the hydrogen carbonate salt is selected from sodium hydrogen carbonate (NaHCO₃), potassium hydrogen carbonate (KHCO₃) and ammonium hydrogen carbonate ((NH₄)HCO₃). In some embodiments, the hydrogen carbonate salt is ammonium hydrogen carbonate ((NH₄)HCO₃).

In some embodiments, the sulphate salt is selected from sodium sulphate (Na₂SO₄), potassium sulphate (K₂SO₄) and ammonium sulphate ((NH₄)₂SO₄). In some embodiments, the sulphate salt is ammonium sulphate ((NH₄)₂SO₄).

In some embodiments, component (a) is a hydrogen phosphate salt, i.e. a salt including the anion HPO₄²⁻.

Particularly good fire extinguishing properties are observed for the fire extinguishing liquid when the salts in components (a), (b) and (c) are each ammonium salts. Without wishing to be bound by theory, it is believed that this may be at least partly due to the increased quantity of ammonia produced through thermal decomposition of ammonium salts, which has a suffocating effect on the fire.

Thus in some embodiments, the fire extinguishing liquid comprises:
diammonium hydrogen phosphate ((NH₄)₂HPO₄),
ammonium bicarbonate (NH₄HCO₃), and
ammonium sulphate ((NH₄)₂SO₄).

In some embodiments, component (a) (the phosphate, hydrogen phosphate or dihydrogen phosphate salt) consists of a hydrogen phosphate salt. In some embodiments, component (a) (the phosphate, hydrogen phosphate or dihydrogen phosphate salt) consists of diammonium hydrogen phosphate ((NH₄)₂HPO₄).

In some embodiments, component (b) (the hydrogen carbonate salt) consists of ammonium bicarbonate (NH₄HCO₃).

In some embodiments, component (c) (the sulphate salt) consists of ammonium sulphate ((NH₄)₂SO₄).

In some embodiments, the fire extinguishing liquid comprises:
(a) one or more of a phosphate, hydrogen phosphate or dihydrogen phosphate salt;
(b) a hydrogen carbonate salt;
(c) a sulphate salt; and
(d) propylene glycol (C₃H₈O₂).

In this way, the fire extinguishing liquid is able to operate at lower temperatures without freezing due to the presence of propylene glycol in the composition. In some cases, the fire extinguishing liquid may be able to operate at temperatures as low as −20° C. without freezing. As such, the liquid may enable liquid-based fire extinguishers to operate in colder climates, as described above.

Herein, the terms “propylene glycol” and “monopropylene glycol” may be used interchangeably to refer to the compound:

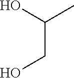

In some embodiments, the fire extinguishing liquid comprises:
diammonium hydrogen phosphate ((NH₄)₂HPO₄),
ammonium bicarbonate (NH₄HCO₃),
ammonium sulphate ((NH₄)₂SO₄) and
propylene glycol (C₃H₈O₂).

Preferably, the fire extinguishing liquid is an aqueous solution of the above mentioned components. In other words, the fire extinguishing liquid comprises:
(a) one or more of a phosphate, hydrogen phosphate or dihydrogen phosphate salt;
(b) a hydrogen carbonate salt;
(c) a sulphate salt;
(d) optionally propylene glycol (C₃H₈O₂); and
(e) water.

Optional features of the invention will now be set out. These are applicable singly or in any combination with any aspect of the invention.

It has been found that a fire extinguishing liquids of the present invention demonstrate better fire extinguishing results than known liquids. In preferred embodiments, the components set out above are dissolved in a solvent, preferably water, and more preferably demineralized water.

In order to better understand why the liquid displays these advantageous effects, the mechanism of combustion must first be understood namely the process of: heating→decomposition (or gasification)→ignition→combustion→extended chain of flame. Fire retardants or suppressants work by interfering with one or more of the steps in this mechanism. For example they may work by blocking the oxygen supply or forming an oxygen blockade layer; controlling the production of combustion gas; lowering the temperature of the combustibles, or generating incombustible gas and diluting combustible gas.

Examples of fire extinguishing mechanisms are as follows:
(i) Suffocation, in which gases generated by the heating of components in the fire extinguishing liquid (i.e. gas which is vaporized and generated by heat energy of the combustibles), e.g. ammonia, carbon dioxide, nitrogen, or water vapour, have a dilution effect on the combustible gas, and a suffocation effect due to oxygen blockade.
(ii) Endothermic effects, wherein the sublimation, vaporization, decomposition or heating of components within the fire extinguishing liquid (or combustion residues) leads to a temperature fall, as the heat energy released by the fire is expended in heating/vaporizing components of the liquid, rather than stoking the fire.
(iii) Restraining effects, in which the fire extinguishing liquid confines the combustibles, and has a fireproofing effect on said combustibles (i.e. forming a protective layer), both restraining the outbreak of gas and preventing the underlying material from igniting. Alternatively, the non-combustible solid combustion residues may provide the fireproofing effect.

Turning specifically to the components of the liquid of the present invention: without wishing to be bound by theory it is believed that when coming into contact with the heat of a fire, diammonium hydrogen phosphate decomposes according to: (NH₄)₂HPO₄→H₃PO₄+2NH₃, producing ammonia gas. The ammonia has a suffocating effect on the fire, by replacing the oxygen in the surroundings. It also helps to cool the combustibles by its heat of vaporization (see the endothermic effect above). Furthermore, chemical agents which are not vaporized stick to any combustibles, and in so doing make them non-combustible, by the restraining effect described above.

Similar to the diammonium hydrogen phosphate, without wishing to be bound by theory it is believed that when coming into contact with the heat of the fire, the ammonium hydrogen carbonate decomposes according to: NH₄HCO₃→NH₃+CO₂+H₂O. The ammonia has the same effects as for the diammonium hydrogen phosphate. In addition the CO₂ and H₂O also serve to have a suffocating effect on the flames.

Further without wishing to be bound by theory it is believed that ammonium sulphate decomposes by pyrolysis according to (NH₄)₂SO₄→2NH₃+H₂SO₄, followed by the decomposition of the H₂SO₄ product into SO₃ and H₂O. Treating a source of combustion with (NH₄)₂SO₄ lowers the threshold temperature for pyrolysis and combustion and provides an increase in the residue or char production, which further contributes to retardancy.

When monopropylene glycol is present in the fire extinguishing liquid, this lowers the freezing point of the liquid. In doing so, it enables the liquid to be used in colder temperatures, specifically at temperature as low as +20° C. Furthermore, in contrast to other “anti-freezing” agents, monopropylene glycol is advantageous since it is both environmentally friendly and non-toxic. Being able to operate at lower temperatures is especially useful, for example, in cold countries where prior art fire extinguishing liquid would freeze, greatly reducing its effectiveness. Prior to now, it was necessary to use powder or CO₂ based extinguishers in such cold countries.

Preferably, at atmospheric pressure, the fire extinguishing liquid has a freezing point of at most 0° C., for example at most −5° C., at most −10° C., at most −15° C. or at most −20° C.

In some embodiments, the molar ratio in the fire extinguishing liquid of the phosphate, hydrogen phosphate or dihydrogen phosphate anion in (a), to the hydrogen carbonate anion in (b), is from 5:1 to 20:1, preferably from 6:1 to 15:1.

In some embodiments, the molar ratio in the fire extinguishing liquid of the phosphate, hydrogen phosphate or dihydrogen phosphate anion in (a), to the sulphate anion in (c), is from 3:1 to 15:1, preferably from 4:1 to 10:1.

In some embodiments, the molar ratio in the fire extinguishing liquid of the phosphate, hydrogen phosphate or dihydrogen phosphate anion in (a), to the propylene glycol in (d), is from 0.3:1 to 0.8:1, preferably from 0.4:1 to 0.7:1.

In some embodiments, the fire extinguishing liquid also comprises water as a solvent, alongside the components mentioned above, such that the liquid is an aqueous solution of the specified components. In some embodiments, the molar ratio in the fire extinguishing liquid of the phosphate, hydrogen phosphate or dihydrogen phosphate anion in (a), to water, is from 0.01:1 to 0.5:1, preferably from 0.03:1 to 0.2:1.

Such ratios of components have been found to lead to enhanced firefighting abilities of the fire extinguishing liquid.

In the following description, unless otherwise specified, percentages refer to weight percentages (wt %). By “weight percentage”, we mean the percentage by weight relative to the total weight of the liquid.

In some embodiments, the liquid comprises at least 10 wt % diammonium hydrogen phosphate, for example at least 11 wt %, at least 12 wt %, at least 13 wt %, at least 14 wt %, at least 15 wt % or at least 16 wt %. In some embodiments, the liquid comprises up to 30 wt % diammonium hydrogen phosphate, for example up to 29 wt %, up to 28 wt %, up to 27 wt %, up to 26 wt %, up to 25 wt %, up to 24 wt %, up to 23 wt %, up to 22 wt %, up to 21 wt % or up to 20 wt %.

In some embodiments, the liquid comprises at least 0.01 wt % ammonium bicarbonate, for example at least 0.02 wt %, at least 0.03 wt %, at least 0.04 wt %, at least 0.05 wt %, at least 0.1 wt %, at least 0.2 wt %, at least 0.3 wt %, at least 0.4 wt %, at least 0.5 wt %, at least 0.6 wt %, at least 0.7 wt %, at least 0.8 wt %, at least 0.9 wt % or at least 1.0 wt %. In some embodiments, the liquid comprises up to 5 wt % ammonium bicarbonate, for example up to 4.5 wt %, up to 4 wt %, up to 3.5 wt %, up to 3 wt %, up to 2.5 wt % or up to 2 wt %.

In some embodiments, the liquid comprises at least 0.01 wt % ammonium sulphate, for example at least 0.02 wt %, at least 0.03 wt %, at least 0.04 wt %, at least 0.05 wt %, at least 0.1 wt %, at least 0.2 wt %, at least 0.3 wt %, at least 0.4 wt %, at least 0.5 wt %, at least 1.0 wt %, at least 1.5 wt %, at least 2 wt %, at least 2.5 wt % or at least 3 wt %. In some embodiments, the liquid comprises up to 10 wt % ammonium sulphate, for example up to 9 wt %, up to 8 wt %, up to 7 wt %, up to 6 wt %, up to 5 wt % or up to 4 wt %.

In some embodiments, the liquid comprises at least 10 wt % monopropylene glycol, for example at least 10.5 wt %, at least 11 wt %, at least 11.5 wt %, at least 12 wt %, at least 12.5 wt %, at least 13 wt %, at least 13.5 wt %, at least 14 wt %, at least 14.5 wt % or at least 15 wt %. In some embodiments, the liquid comprises up to 20 wt % ammonium sulphate, for example up to 19.5 wt %, up to 19 wt %, up to 18.5 wt %, up to 18 wt %, up to 17.5 wt % or up to 17 wt %.

In some embodiments, alongside the above components the liquid comprises balance solvent, preferably water, more preferably demineralised water. In some embodiments, the liquid comprises at least 30 wt % water, for example at least 35 wt %, at least 40 wt %, at least 45 wt % or at least 50 wt %. In some embodiments, the liquid comprises up to 70 wt % water, for example up to 65 wt % or up to 60 wt %.

In some embodiments, the liquid comprises
10 to 35 wt %, for example 20 to 30 wt % diammonium hydrogen phosphate;
0.01 to 5 wt %, for example 1 to 4 wt % ammonium bicarbonate;
0.01 to 10 wt %, for example 3 to 8 wt % ammonium sulphate;
optionally 2 to 6 wt %, for example 3 to 5 wt % firefighting foam component; and
balance water, to provide a total of 100 wt %.

In some embodiments, the liquid comprises
10 to 35 wt %, for example 20 to 30 wt % diammonium hydrogen phosphate;
0.01 to 5 wt %, for example 1 to 4 wt % ammonium bicarbonate;

0.01 to 10 wt %, for example 3 to 8 wt % ammonium sulphate;
optionally 2 to 6 wt %, for example 3 to 5 wt % firefighting foam component; and
50 to 70 wt % water;
   wherein the amount of all components totals 100 wt %.

In some embodiments, the liquid comprises
10 to 30 wt % diammonium hydrogen phosphate;
0.01 to 5 wt % ammonium bicarbonate;
0.01 to 10 wt % ammonium sulphate;
10 to 20 wt % monopropylene glycol;
optionally 2 to 4 wt % firefighting foam component; and
balance water, to provide a total of 100 wt %.

In some embodiments, the liquid comprises
10 to 30 wt % diammonium hydrogen phosphate;
0.01 to 5 wt % ammonium bicarbonate;
0.01 to 10 wt % ammonium sulphate;
10 to 20 wt % monopropylene glycol;
optionally 2 to 4 wt % firefighting foam component;
and
50 to 70 wt % water;
   wherein the amount of all components totals 100 wt %.
The liquid may contain 50% to 70% water, and more preferably 55% to 65% water, and more preferably still 58% to 60% water.
The liquid may contain 10% to 30% diammonium hydrogen phosphate, and more preferably 15% to 25% diammonium hydrogen phosphate, and more preferably still 16% to 20% diammonium hydrogen phosphate.
The liquid may contain 0.01% to 5% ammonium bicarbonate, and more preferably 0.5% to 3% ammonium bicarbonate, and more preferably still 1% to 2% ammonium bicarbonate.
The liquid may contain 0.01% to 10% ammonium sulphate, and more preferably 2% to 5% ammonium sulphate, and more preferably still 3% to 4% ammonium sulphate.
The liquid may contain 10% to 20% monopropylene glycol, and more preferably 12.5% to 17.5% monopropylene glycol, and more preferably still 15% to 17% monopropylene glycol.

In some embodiments, the weight ratio of diammonium hydrogen phosphate to ammonium bicarbonate in the extinguishing liquid is at least 2:1, for example at least 2.1:1, at least 2.2:1, at least 2.3:1, at least 2.4:1 or at least 2.5:1. In some embodiments, the weight ratio of diammonium hydrogen phosphate to ammonium bicarbonate in the extinguishing liquid is at least 3:1, for example at least 4:1, at least 5:1, at least 6:1, at least 7:1 or at least 8:1.

In some embodiments, the weight ratio of diammonium hydrogen phosphate to ammonium sulphate in the extinguishing liquid is at least 2:1, for example at least 2.1:1, at least 2.2:1, at least 2.3:1, at least 2.4:1 or at least 2.5:1. In some embodiments, the weight ratio of diammonium hydrogen phosphate to ammonium sulphate in the extinguishing liquid is at least 3:1, for example at least 3.5:1 or at least 4.0:1.

The fire extinguishing liquid may further include a firefighting foam component. Such a component both adds to the cooling effect of the liquid, and coats the combustible material, preventing oxygen contact and suppressing combustion. The foam component may include a surfactant, to lower the surface tension of the water in the foam. By lowering the surface tension, the water is able to better wet the surface of the combustible material, further reducing oxygen contact. In preferred embodiments, the firefighting foam component is a firefighting foam. In some embodiments, the firefighting foam component is an aqueous film forming foam (AFFF), such as FOMTEC® AFFF 3%. The selection of firefighting foam component may depend on the particular intended application of the fire extinguishing liquid, as would be understood by the skilled person.

In some embodiments, the firefighting foam component comprises diethylene glycol monobutyl ether, sulphuric acid mono-C6-C12-alkyl esters sodium salts, propan-1,2-diol, alkyl polyglycoside and ethylene oxide polymer.

In some embodiments, the firefighting foam component comprises 2-methylpentane-2-4-diol, sodium decyl sulphate and sodium octyl sulphate.

In some embodiments, the liquid contains at least 2% firefighting foam component, for example at least 2.5%, at least 3%, at least 3.5%, at least 4% or at least 4.5%. The inventors have found that the firefighting abilities of the liquid are dramatically improved when the composition comprises at least 6% firefighting foam component, for example at least 6.5%, at least 7%, at least 7.5%, at least 8%, at least 8.5%, at least 9% or at least 9.5%.

In some embodiments, the liquid contains up to 12% firefighting foam component, for example up to 11.5%, up to 11% or up to 10.5%.

It has been found that liquids having compositions falling within the ranges set out above demonstrate improved fire extinguishing capabilities. For example, such liquids may providing reduced extinguishing time, reduced residual temperatures and/or a reduced quantity of liquid necessary to achieve extinguishment.

A second aspect of the invention is a method of manufacturing a fire extinguishing liquid comprising the step of mixing (a) one or more of a phosphate, hydrogen phosphate or dihydrogen phosphate salt; (b) a hydrogen carbonate salt; (c) a sulphate salt; and a liquid vehicle. In some embodiments, the liquid vehicle is water, preferably demineralised water.

In some embodiments, the method comprises the step of mixing diammonium hydrogen phosphate ((NH₄)₂HPO₄), ammonium bicarbonate (NH₄HCO₃), ammonium sulphate ((NH₄)₂SO₄) and a liquid vehicle. In some embodiments, the liquid vehicle is water, preferably demineralised water.

In some embodiments, the method further comprises mixing propylene glycol (C₃H₈O₂) with the diammonium hydrogen phosphate ((NH₄)₂HPO₄), ammonium bicarbonate (NH₄HCO₃), ammonium sulphate ((NH₄)₂SO₄) and liquid vehicle.

In some embodiments, the method of manufacturing the fire extinguishing liquid comprises the steps of:
(A) heating water to a temperature above room temperature; and
(B) adding diammonium hydrogen phosphate ((NH₄)₂HPO₄), ammonium bicarbonate (NH₄HCO₃) and ammonium sulphate ((NH₄)₂SO₄) to the water.

In some embodiments the method further comprises adding propylene glycol (C₃H₈O₂) to the water in step (B).

In some embodiments, the method further comprises the addition of the firefighting foam component described above.

In some embodiments, the method comprises mixing the solution after the addition of one or more of diammonium hydrogen phosphate ((NH₄)₂HPO₄), ammonium bicarbonate (NH₄HCO₃), ammonium sulphate ((NH₄)2SO₄) and propylene glycol (C₃H₈O₂). In some embodiments, after step (B) the method includes an additional step (C) of cooling the solution to below 25° C.

In some embodiments, after step (C) the method includes an additional step (D) of filtering the solution to remove undissolved residue. This filtering step may be carried out using any well-known filtration technique, including but not limited to passing the solution through filter paper or a sieve.

‘Room temperature’ refers to a temperature of around 21° C.

In some embodiments, the water is first heated in step (A) to a temperature in the range 50 to 70° C. before any of the other components are added. This leads to improved dissolution of the other components of the composition. In some embodiments, the heating is carried out using an immersion heater, such as an electric element within the mixing tank. Other suitable methods of heating the water are known to the skilled person.

In some embodiments, each of diammonium hydrogen phosphate ((NH₄)₂HPO₄), ammonium bicarbonate (NH₄HCO₃), ammonium sulphate ((NH₄)₂SO₄) and optionally propylene glycol (C₃H₈O₂) are added to the water separately. In some embodiments, diammonium hydrogen phosphate ((NH₄)₂HPO₄) is added to the water in a first step, followed by the remaining components. In some embodiments, propylene glycol (C₃H8O₂) is added after each of diammonium hydrogen phosphate ((NH₄)₂HPO₄), ammonium bicarbonate (NH₄HCO₃) and ammonium sulphate ((NH₄)₂SO₄) have been added.

In some embodiments, the method of manufacturing the fire extinguishing liquid comprises the steps of:
(i) heating water to a temperature above room temperature, preferably to a temperature in the range 50 to 70° C.;
(ii) adding diammonium hydrogen phosphate and mixing until dissolved;
(iii) adding ammonium bicarbonate and mixing until dissolved;
(iv) adding ammonium sulphate and mixing until dissolved; and
(v) optionally adding monopropylene glycol and mixing until dissolved.

In some embodiments, after optional step (v) the method includes an additional step (vi) of cooling the solution of water, diammonium hydrogen phosphate, ammonium bicarbonate and ammonium sulphate to below 25° C.

In some embodiments, after step (vi) the method includes an additional step (vii) of filtering the solution to remove undissolved residue. This filtering step may be carried out using any well-known filtration technique, including but not limited to passing the solution through filter paper or a sieve.

The amount of each component added to the water is preferably selected to arrive at a composition having:
50% to 70% of water, and more preferably 55% to 65% of water, and more preferably still 58% to 60% of water.
10% to 30% diammonium hydrogen phosphate, and more preferably 15% to 25% diammonium hydrogen phosphate, and more preferably still 16% to 20% diammonium hydrogen phosphate.
0.01% to 5% ammonium bicarbonate, and more preferably 0.5% to 3% ammonium bicarbonate, and more preferably still 1% to 2% ammonium bicarbonate.
0.01% to 10% ammonium sulphate, and more preferably 2% to 5% ammonium sulphate, and more preferably still 3% to 4% ammonium sulphate.
10% to 20% monopropylene glycol, and more preferably 12.5% to 17.5% monopropylene glycol, and more preferably still 15% to 17% monopropylene glycol.

In steps (ii) to (iv), the components are preferably added to the mixture in their natural physical form, that is in solid form, preferably in the form of grains or a powder. Throughout these steps the diammonium hydrogen phosphate, ammonium bicarbonate and the ammonium sulphate are preferably added while the mixture is being mixed or stirred. In optional step (v) the monopropylene glycol is preferably added in its natural physical form, namely in liquid form.

The method may further include a step of adding a firefighting foam component as described earlier in the application. As above, the weight of firefighting foam component is preferably selected to arrive at an overall composition having 2% to 6%, for example 2% to 4% of firefighting foam component.

By heating the water first, in step (i), the dissolution of the components in steps (ii) to (v) is improved. In preferred embodiments, the addition of the diammonium hydrogen phosphate is carried out in small increments. In this way, the chance of a rapid reduction in the temperature of the water is prevented, which may otherwise lead to a reduction in solubility. Specifically, in preferred embodiments, after a small amount of diammonium hydrogen phosphate is added to the water, that small amount should dissolve fully before a second small amount is added. In some embodiments, the total amount of diammonium hydrogen phosphate is added to the liquid vehicle in two or more batches, for example three, four or five batches, allowing for full dissolution, preferably with mixing, after each batch addition. In some embodiments, after all of the diammonium hydrogen phosphate is added, the mixture is mixed or stirred for 10 to 30 minutes to ensure an even distribution of the diammonium hydrogen phosphate throughout the mixture. Furthermore, throughout the addition steps (ii) to (iv), it is preferable that the water is maintained at a temperature from 50° C. to 70° C., in order to aid the dissolution of the diammonium hydrogen phosphate, ammonium bicarbonate and ammonium sulphate in steps (ii) to (iv) respectively.

After step (iii), the mixture may be mixed or stirred for 5 to 20 minutes, again to ensure uniform distribution of the ammonium bicarbonate throughout the mixture. More preferably, the mixture is mixed or stirred for about 10 minutes. For the same reason, after the addition of ammonium sulphate in step (iv), the mixture may be mixed or stirred for a further 20 to 40 minutes, and preferably for about 20 minutes.

In step (vi), it is preferable that the water is cooled to below 25° C., for example below 24° C., below 23° C., below 22° C., below 21° C. or below 20° C. In some embodiments, the solution is left to cool naturally for a period of at least 5 hours, such as at least 6 hours, at least 7 hours or at least 8 hours. By cooling the mixture to a temperature which is approximately room temperature, the capacity of the water to hold the diammonium hydrogen phosphate, ammonium bicarbonate and ammonium sulphate in solution is decreased. As a result, a portion of any or all of these components may precipitate out of solution. Clearly, it is undesirable that this happens when the liquid has been packaged in e.g. a fire extinguisher. For example, such precipitation may cause the solid grains to block the extinguisher nozzle or any valves within extinguishers or aerosols, which risks reducing its effectiveness, or even rendering the fire extinguisher completely inoperable. So, the combination of the cooling in step (vi) and the filtering in step (vii), which removes any diammonium hydrogen phosphate, ammonium bicarbonate and ammonium sulphate which may have precipitated as a result of cooling, and also any undissolved residues or impurities, ensures that the liquid does not contain any solid particulate matter which could block or damage a fire extinguisher in which the liquid may be contained.

The filtering may be performed using a mesh, the mesh size (i.e. the average size of the holes in the mesh) of which, is preferably selected to catch (i.e. filter out) particles whose dimensions are such that they risk damaging or blocking a fire extinguisher. For example, the mesh size may be 0.5 mm or less. More preferably the mesh size is 0.1 mm or less, and more preferably still, the mesh size is 0.05 mm or less.

The method may include a further step of filling a fire extinguisher with the liquid. Step (vii), the filtering step, may take place as the fire extinguisher is being filled, in order to minimize the number of steps in the manufacturing process.

A third aspect of the present invention provides a fire extinguisher (i.e., a fire extinguishing device) containing the liquid according to the first aspect of the present invention. The liquid may include any of the optional features which have been set out above with respect to the first and second aspects of the invention, where compatible.

A variety of fire extinguishing devices may be used to contain and deliver the fire extinguishing liquid according to the invention. For example, self-contained hand-held pressurised extinguishers may be used, wherein the liquid is delivered through a nozzle.

The liquid may also be added to a sealed sachet, which could find use for example in fighting pan fires in a domestic environment. More sophisticated fire-fighting systems could also employ the fire extinguishing liquid of the invention, for example hose reel jets, high pressure hose reel jets, compressed air foam systems and ultra high pressure lance systems. Such systems are more suited for use by professional fire-fighters, such as fire and rescue service crew.

The liquid may be used in its concentrated form according to a composition as described herein, or may be diluted further with a liquid vehicle such as water. For example, the liquid may be diluted with water to provide a weight ratio of extinguishing liquid:water in the range of from 4:96 to 50:50, preferably from 6:94 to 30:70.

### BRIEF DESCRIPTION OF THE DRAWINGS

Embodiments of the invention will now be described by way of example with reference to the accompanying drawings, in which:

FIG. 1 is a graph of temperature, as measured at three positions within a fire, plotted against the period of time from initiation of the extinguishing process up to complete extinguishment with an extinguishing liquid according to the invention.

FIG. 2 is a graph of temperature, as measured at three positions within a fire, plotted against the period of time from initiation of the extinguishing process up to complete extinguishment with water alone.

### EXAMPLES

### Example 1

A fire extinguishing liquid was prepared according to the following method:
1) 727 kg of demineralized water was run into a mixing vessel, and heated to 40° C. using an electric element located within the mixing vessel.
2) 350 kg of diammonium hydrogen phosphate was added slowly to the demineralized water in batches, allowing each batch to dissolve before making another addition. Thereafter, the solution was mixed for 15 to 20 minutes until the last of the diammonium hydrogen phosphate was dissolved.
3) 30 kg of ammonium bicarbonate was added while mixing. After all of the ammonium bicarbonate was dissolved, the solution was mixed for a further 10 minutes.
4) 80 kg of ammonium sulphate was added while mixing. After all of the ammonium sulphate was dissolved, the solution was mixed for a further 30 minutes.
5) 50.75 kg of FOMTEC® AFFF 3% was added, while slowly mixing (to avoid foaming). The mixture was allowed to cool to below 25° C., and was then passed through a 20 μm filter and the filtrate was passed directly into a fire extinguisher vessel.

### Example 2

A fire extinguishing liquid was prepared according to the following method:
1) 727 kg of demineralized water was run into a mixing vessel, and heated to 60° C. using an electric element located within the mixing vessel.
2) 210 kg of diammonium hydrogen phosphate was added slowly to the demineralized water in batches, allowing each batch to dissolve before making another addition. Thereafter, the solution was mixed for 15 to 20 minutes until the last of the diammonium hydrogen phosphate was dissolved.
3) 20 kg of ammonium bicarbonate was added while mixing. After all of the ammonium bicarbonate was dissolved, the solution was mixed for a further 10 minutes.
4) 48 kg of ammonium sulphate was added while mixing. After all of the ammonium sulphate was dissolved, the solution was mixed for a further 30 minutes.
5) 202.3 kg of monopropylene glycol was added while mixing, and the solution was stirred until fully dissolved.
6) 30.45 kg of FOMTEC® AFFF 3% was added, while slowly mixing (to avoid foaming). The solution was then mixed and circulated for a further 30 minutes.

The mixture was allowed to cool to 18° C., and was then passed through a 20 μm filter and the filtrate was passed directly into a fire extinguisher vessel.

The following examples show that the extinguishing liquid of the invention is useful in fighting fires of at least Classes A, B, D and F.

### Example 3

The liquid made in Example 1 was tested for fire extinguishing ability using fire performance tests according to section 15 of European standard EN 3-7:2004+A1:2007.

In a first test, the liquid was tested in a 6 L stored pressure extinguisher (N₂—15 bar/20° C.) with inner nozzle diameter of 6×2 mm. The results showed that the fire rating of the extinguisher was 34 A (with an extinguishing time of 148 s) and 75 F (with an extinguishing time of 2 s).

In a second test, the liquid was tested in a 2 L stored pressure extinguisher (N₂—15 bar/20° C.) with inner nozzle diameter of 3×2.2 mm. The results showed that the fire rating of the extinguisher was 13 A (with an extinguishing time of 110 s) and 25 F (with an extinguishing time of 3 s).

The ratings for a number of typical comparative fire extinguishing media are provided below:

| | | |
|---|---|---|
| Extinguishing medium | Size | Rating |

| | | | |
|---|---|---|---|
| CO₂ | 2 | kg | 34 B |
| | 5 | kg | 70 B |
| Dry powder | 1 | kg | 8A; 34B |
| | 2 | kg | 13A; 89B |
| | 3 | kg | 21A; 113B |
| | 4 | kg | 27A; 144B |
| | 6 | kg | 43A; 233B |
| | 9 | kg | 55A; 233B |
| | 12 | kg | 55A; 233B |

| | | |
|---|---|---|
| Specialist dry powder | — | Metal fires only |

| | | | |
|---|---|---|---|
| Wet chemical | 2 | L | 34B; 25F |
| | 3 | L | 13A; 70B; 40F |
| | 6 | L | 21A; 113B; 75F |
| Water | 6 | L | 13A |
| | 9 | L | 21A |
| Water additive | 3 | L | 13A |
| | 6 | L | 27A |
| Foam | 2 | L | 8A; 55B |
| | 3 | L | 13A; 89B |
| | 6 | L | 21A; 144B |
| | 9 | L | 27A; 233B |

In general, powder can be used for Types A, B and C and can also show the electrical symbol. Water is for Type A only. Foam is for Types A and B. Wet chemical is for Types A, B and F. CO₂ is for Type B and electrical.

In the following Examples, all test temperatures were recorded using a thermal image camera recording the peak temperature at the hottest point of the fire with a maximum fluctuation of ±20 degrees, times were recorded via a stopwatch. All tests were recorded with video footage.

### Example 4—9 L Extinguisher Used on Small Domestic Fire Class A

Two separate cribs, of a similar size (approx. 1 m³), containing a mixture of wood planks, paper and straw were placed in a compartment and ignited separately. This test was designed to replicate the size and heat release rate (approx. 300 Kw-750 Kw) of a small domestic Class A compartment fire.

The first crib was placed in the centre of the room, ignited and allowed to achieve a peak temperature of 450° C. with full involvement of the wood planking. Once peak temperature was achieved an attempt was made to extinguish the fire using a 9 L water extinguisher charged to 11 bar pressure.

The second crib was placed adjacent to a large concrete structural support, this allowed for greater fire development and a higher peak temperature of 560° C. An extinguisher (‘Extinguisher A’) filled with the liquid of Example 1, with a stored pressure within the extinguisher of 15 bar, was used to extinguish the fire. All other test parameters were identical.

The water extinguisher was fully discharged in 1 min 17 s and failed to extinguish the fire, with visible flame still being observed on a number of wooden planks. The residual temperature was recorded as 250° C. with re-ignition occurring. The surface temperatures on the wooden planks were also high and didn't allow touching without a gloved hand.

Extinguisher A managed to extinguish the wood within the test fire with only small areas of burning remaining within a couple of areas of straw packing, residual temperatures were recorded at 120° C. in these areas. Surface temperatures were also reduced to such a level that it was possible to pick up wooden planks without a glove or any form of protection. It was noted that the increase in pressure resulted in a rapid discharge of the extinguisher (48 seconds) in comparison to the water extinguisher.

Despite the increase in stored pressure within Extinguisher A, resulting in faster discharge times, the test results show that Extinguisher A clearly outperformed a similar water extinguisher when utilised on a Class A fire.

### Example 5—Larger Domestic Fire (Sofa) Extinguished Using Hose Reel Jet (25 bar)

A 3 seat sofa of modern design and meeting current standards was placed against the rear internal wall of a test compartment and ignited. An initial test was conducted to establish a base line using a 25 bar hose reel jet and water from a peak temperature of approx. 340° C. and a heat release rate of approx. 1-3 MW.

The test was then repeated within the same parameters as the baseline test but using an induced supply of the liquid of Example 1 at 20% via the hose reel jet (‘Extinguisher B’). Higher peak temperatures of 560° C. were also recorded.

Note: Initial test were at a lower peak temperature due to external environmental effects on test compartment (steel shipping container) and the test compartment absorbing a large amount of heat from the test fires. Once these factors were overcome higher temperatures were recorded. Supplementary tests conducted in similar circumstances at a later date recorded peak temperatures of approx. 500° C.

Both fires were extinguished successfully with current operational techniques for compartment firefighting being used to address a Class A fire.

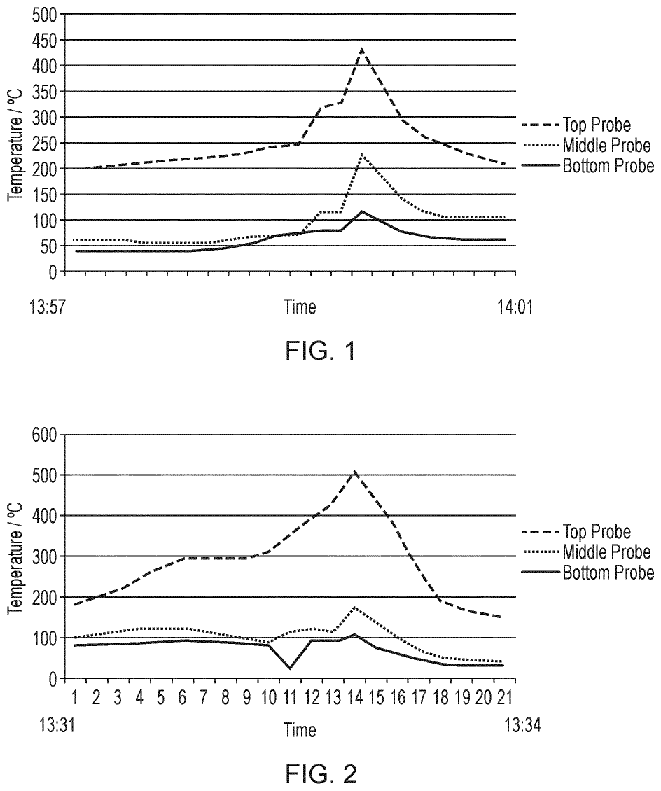

Results of temperature measurements taken from three probes positioned at varying heights within the fire are shown in FIGS. 1 and 2. FIG. 1 shows the measurements recorded through the extinguishing process when Extinguisher B was used. FIG. 2 shows the measurements recorded through the extinguishing process when water alone was used. A rapid ‘knock down’ of the fire was observed when using Extinguisher B, along with less water usage and lower residual temperatures after it was extinguished (100° C. as opposed to 200° C.).

Recorded temperatures within the supplementary tests were broadly similar with Extinguisher B, approx. 30% more efficient than water (see FIGS. 1 and 2) and an identified rapid reduction in temperature within the compartment in comparison to a similar amount of water. There was less steam, and resultant radiated heat, which allowed for a rapid entry and easier progress into the compartment with reduced physiological impact on the firefighter.

### Example 6—Developed Fire in an Average Size 5 Door Family Car

An average sized 5 door family car was ignited and allowed to reach full involvement with fire located in the main passenger and engine compartment.

This test was designed to replicate similar conditions to those experienced by responding operational fire and rescue crews.

All vehicles were drained of fuel and oil, placed in open air and subject to a light breeze. All test fires were started by the ignition of internal seating via a gas powered thermal lance.

Supplementary tests repeated the test process with the addition of specific small fires within the engine and passenger compartment to allow for the testing of smaller 1 and 2 L extinguishers on ‘early stage’ vehicle fires.

The performance of 9 L extinguishers (Extinguisher C) on a developed fire within the primary test car was evaluated using extinguishers charged to 11 Bar and with a structured attack made on the fire using two extinguishers working simultaneously and in conjunction with each other. This test achieved a positive outcome with the fire controlled and extinguished using two extinguishers (a third was used to fully extinguish a small number of ‘hotspots’). This test demonstrated the potential usage of Extinguisher C (carried on smaller appliances) on this type of fire including Class A, B and D.

Supplementary tests were also conducted using smaller 1 and 2 L extinguishers containing the liquid of Example 1 on specific fires within the engine bay and passenger compartment. These tests identified that 2 L was the optimum size, and the easiest to use, for the early extinguishment of small vehicle fires before the arrival of the fire service.

### Example 7—Developed Fire in an Average Size 5 Door Family Car Using a High Pressure Hose Reel Jet (100 bar)

An average sized family car was ignited and allowed to reach full involvement with fire located in the main passenger cabin and engine compartment. This fire was conducted to establish a baseline of data for water usage and environmental impact.

This test was designed to replicate similar conditions to those experienced by responding operational fire service crews.

All vehicles were drained of fuel and oil placed in open air and subject to a light breeze. All test fires were started by the ignition of internal seating via a gas powered thermal lance.

The test was conducted using water alone, and repeated using a high pressure hose reel jet (100 bar) delivering the liquid of Example 1 induced at 20% concentration (‘Extinguisher D’), all other test parameters were the same.

An additional test was conducted using a HYBRID vehicle of a similar size to test the capabilities of Extinguisher D when extinguishing a car fire containing lithium batteries.

The baseline water test extinguished the fire within 1 mine 25 s using approx. 190 L of water. Whilst this was a positive outcome it identified that additional water (approx. 250 L) was required damping down the vehicle and dealing with a number of hotspots, this also took an extended period of time (approx. 15 min of discontinuous application). Additionally there was also a large amount of fire water run off with the potential to pollute the surrounding water course.

The fire was fully extinguished by Extinguisher D, as per the baseline test fire, and within similar timescales for application (the test took 2 min 15 s). Notable differences were that less liquid was used (approx. 60-70 L), no environmental pollution was identified from water run-off and there was no residual heat retained in the vehicle requiring on-going damping down (meaning crews could be released from the incident quicker).

The test fire conducted using the HYBRID car achieved similar results to the normal car with Extinguisher D extinguishing the fire using approx. 60-70 L of extinguishing liquid. The fire was well developed but it was not possible to confirm if the batteries had become fully involved in the fire.

### Example 8—Standing Fuel Fire of Approx. 4-6 m²

A mixture of petrol and diesel was placed into a water filled tray to a depth of approx. 15-20 cm and approx. 4-6 m² in surface area, this was ignited and allowed to reach a peak temperature of approx. 1000° C. Multiple trays were used during testing to ensure any potential build up firefighting media did not detrimentally affect observed results.

An initial baseline test was conducted using 9 L foam extinguishers.

Comparable tests were conducted using 9 L extinguishers charged to 11 Bar pressure and containing the liquid from Example 1 (‘Extinguisher E’) in a direct and indirect application, induced via a compressed air foam system and induced via an in line inductor at 2, 4 and 6% concentration mix.

Additional tests were conducted using similar sized trays, with 100% fuel (mixture of AVGAS and diesel), and extinguished using Extinguisher E. This was to replicate a running fuel fire.

The foam extinguishers were effective on the test fire, which was extinguished in 17.5 s, however significant initial ‘flash back’ was experienced with the operators having to withdraw slightly before re-applying. The foam extinguishers discharged approx. 9 L of foam to ensure the fire was fully extinguished after re-ignition occurred.

No ‘flash back’ was experienced with the Extinguisher E, applied in a combined attack, rapid ‘knock down’ was noted with the test fire extinguished in 15 s and a reduction in temperature from 1000° C. to 50° C. A notable reduction in the amount of solution was also evident (approx. 4 L was used) with no requirement to re-apply media post fire. These results were replicated on the running fuel fire tests with slight increases in solution usage identified as a result of the nature of the fire (although this was still within the capabilities of the extinguisher).

When applied via an in line inductor no significant time difference was identified between 4-6% mix ratio in extinguishing the fire (16-23 seconds), however, ‘burn back’ leading to re-ignition was noted at 4%. At 6% this was not observed and no further application of solution was required after the initial attack.

These tests identified that Extinguisher E performed well when applied to Class B fires in both bulk and pressurised extinguisher form.

### Example 9—Stack of Tyres Involved in Fire

An initial test was conducted with two small stacks of tyres placed next to each other, these were then extinguished at the same time using a 9 L water extinguisher and Extinguisher C, to establish a direct performance comparison. Peak temperatures were recorded at approx. 535° C. with both fires being started via gas powered thermal lance.

The test was repeated using a larger stack of tyres, achieving a peak temperature of approx. 950° C., and extinguished using via a 25 bar hose reel jet and bulk solution from Example 1 induced at 6%.

The initial test demonstrated a rapid ‘knock down’ by Extinguisher C in comparison to water, with the tyres extinguished in 7 s compared to 15 s. There was also a comparable reduction in the amount of solution required (2-3 L instead of 9 L) to extinguish the fire and a significant reduction in polluted firewater. Residual temperatures were comparable for both extinguishers.

The second test provided comparable outcomes to the performance identified in the previous test with approx. 10 L of solution and limited water being used to extinguish the fire in 1 min 27 s and a reduction in temperature from 955° C. to 70° C.

This test confirmed the capability, although limited due to the size of test, in extinguishing a Class A fire involving tyres.

### Example 10—Developed Fire in a ‘Thatch’ Roof

Three comparable timber structures were constructed and straw bales placed on the roof to a depth of approx. 400 mm, these were then secured using metal netting to replicate a traditional thatch roof construction.

All roofs were placed in open air, subjected to a light breeze and ignited via the application of a gas powered thermal lance to the boarding under the end of the roof. This was designed to replicate ignition via heat transfer from a chimney stack. Application of firefighting media was commenced when visible flame was identified on the upper outside edge of the straw.

Three tests were conducted to compare (a) water applied via a hose reel jet, (b) bulk solution from Example 1 induced at 6% and applied via compressed air foam system lance and (c) solution from Example 1 induced at 20% via an ultra high pressure lance system. All tests were of the application of firefighting media and no standard tactics such as the removal of metal netting were employed.

The application (a) had minimal impact with fire spread still being observed after the application of large quantities of water for an extended period of time.

The test (b) injected at low pressure into the thatch using the CAFS lance (but not the CAFS system) produced a slowing of combustion but not full extinguishment. Additionally it used a large amount of water and solution with resultant large amounts of fire water run-off.

Significant positive results were observed in (c), using UHPLS, into the area between unaffected and affected thatch and at an angle parallel to the roof pitch. This created a positive barrier that prevented fire spread and allowed for a direct attack to be conducted to the affected area, it was also noted that there was considerably less water used in comparison to the previous tests and no significant water run-off.

### Example 11—Trials of 1 and 2 L Extinguishers on Specific Fires

Initial tests were conducted to assess the viability and practical usage of 1 and 2 L extinguishers with varying discharge nozzles containing the solution of Example 1 for specific small scale Class A and B fires.

A test was conducted to extinguish a small fire in a car engine compartment, this was designed to assess the optimum size of extinguisher required to safely deal with an ‘early stage’ car fire. This test was repeated on a small passenger compartment fire.

Various discharge nozzles were tested to find the optimum discharge spray pattern required to extinguish fires caused by petrol bombs or similar.

Testing identified that 1 L extinguishers, while extinguishing the fire, provided no safety margin in case of unplanned fire development or a requirement for multiple applications.

Despite the slight increase in weight and size no significant detrimental effect was identified with the larger extinguisher, however, safety was increased and multiple applications were possible. Optimum extinguisher size was therefore identified as 2 L.

The optimum discharge nozzle was identified as a narrow angled cone producing a medium coarseness spray, other designs resulted in either to wider spray, limited throw or a combination of both.

### Example 12—Pan fire

Tests were conducted on cooking pan fires using pan fire extinguisher sachets containing the solution of Example 1, these worked well, extinguishing a chip pan fire in a matter of seconds. It was also easy to use and produced no risk for the person applying it.

### Example 13

In the Example, the fire extinguishing liquid made in Example 2 was tested to determine its freezing properties.

The freezing point of the liquid was found to be −20° C. The liquid is therefore suitable for use in low-temperature environments.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above are hereby incorporated by reference.

1. A fire extinguishing liquid comprising:
(a) one or more of a phosphate, hydrogen phosphate or dihydrogen phosphate salt;
(b) a hydrogen carbonate salt; and
(c) a sulphate salt.

2. The fire extinguishing liquid according to claim 1, further comprising monopropylene glycol (C₃H₈O₂).

3. The fire extinguishing liquid according to claim 1, wherein the salts are all dissolved in a liquid vehicle.

4. The fire extinguishing liquid according to claim 3, wherein the liquid vehicle is water, the water optionally being demineralized water.

5. (canceled)

6. The fire extinguishing liquid according to claim 1, wherein the molar ratio in the fire extinguishing liquid of the phosphate, hydrogen phosphate or dihydrogen phosphate anion in (a), to the hydrogen carbonate anion in (b), is from 5:1 to 20:1.

7. The fire extinguishing liquid according to claim 1, wherein the molar ratio in the fire extinguishing liquid of the phosphate, hydrogen phosphate or dihydrogen phosphate anion in (a), to the sulphate anion in (c), is from 3:1 to 15:1.

8. The fire extinguishing liquid according to claim 1, wherein the molar ratio in the fire extinguishing liquid of the phosphate, hydrogen phosphate or dihydrogen phosphate anion in (a), to the propylene glycol in (d), is from 0.3:1 to 0.8:1.

9. The fire extinguishing liquid according to claim 4, wherein the molar ratio in the fire extinguishing liquid of the phosphate, hydrogen phosphate or dihydrogen phosphate anion in (a), to water, is from 0.01:1 to 0.5:1.

10. The fire extinguishing liquid according to claim 1, wherein:
the hydrogen phosphate salt comprises diammonium hydrogen phosphate ((NH₄)₂HPO₄),
the carbonate salt comprises ammonium bicarbonate (NH₄HCO₃), and
the sulphate salt comprises ammonium sulphate ((NH₄)₂SO₄).

11. The fire extinguishing liquid according to claim 10, wherein the weight ratio of diammonium hydrogen phosphate to ammonium bicarbonate in the extinguishing liquid is at least 3:1, preferably at least 4:1.

12. A fire extinguishing liquid according to claim 10, wherein the weight ratio of diammonium hydrogen phosphate to ammonium sulphate in the extinguishing liquid is from 2:1 to 8:1.

13. A fire extinguishing liquid according to claim 4, wherein the fire extinguishing liquid comprises 50% to 70% water by weight, optionally 55% to 65% water by weight, optionally 58% to 60% water by weight.

14. (canceled)

15. (canceled)

16. The fire extinguishing liquid according to claim 10, wherein the fire extinguishing liquid comprises 10% to 30% diammonium hydrogen phosphate by weight, optionally 15% to 25% diammonium hydrogen phosphate by weight, optionally 16% to 20% diammonium hydrogen phosphate by weight.

17. (canceled)

18. (canceled)

19. A fire extinguishing liquid according to claim 10, wherein the fire extinguishing liquid comprises 0.01% to 5% ammonium bicarbonate by weight, optionally 0.5% to 3% ammonium bicarbonate by weight, optionally 1% to 2% ammonium bicarbonate by weight.

20. (canceled)

21. (canceled)

22. A fire extinguishing liquid according to claim 10, wherein the fire extinguishing liquid comprises 0.01% to 10% ammonium sulphate by weight, optionally 2% to 5% ammonium sulphate by weight, optionally 3% to 4% ammonium sulphate by weight.

23. (canceled)

24. (canceled)

25. A fire extinguishing liquid according to claim 2, wherein the fire extinguishing liquid comprises 10% to 20% monopropylene glycol by weight, optionally 12.5% to 17.5% monopropylene glycol by weight, optionally 15% to 17% monopropylene glycol by weight.

26. (canceled)

27. (canceled)

28. A fire extinguishing liquid according to claim 1, further including a firefighting foam component.

29. A fire extinguishing liquid according to claim 28, wherein the firefighting foam component includes a surfactant.

30. A fire extinguishing liquid according to claim 29, wherein the firefighting foam component is an aqueous film forming foam (AFFF).

31. A fire extinguishing liquid according to claim 28, wherein the fire extinguishing liquid comprises 2% to 12% firefighting foam component by weight, optionally 6 to 12% firefighting foam component by weight.

32-42. (canceled)

43. A fire extinguisher containing the fire extinguishing liquid of claim 1.

44-45. (canceled)

46. A method of extinguishing a fire, comprising applying the fire extinguishing liquid of any claim 1 to the fire.
